(19) United States
(12) Patent Application Publication
(10) Pub. No.: US 2013/0347013 A1
(43) Pub. Date: Dec. 26, 2013

(54) INTERACTIVE TELEVISION SHOPPING VIA A PAYMENT PROVIDER

(71) Applicant: Sridhar Sivaraman, Chennai (IN)

(72) Inventor: Sridhar Sivaraman, Chennai (IN)

(73) Assignee: eBay Inc., San Jose, CA (US)

(21) Appl. No.: 13/530,537

(22) Filed: Jun. 22, 2012

(51) Int. Cl. H04N 7/16

(52) U.S. Cl. 725/5

(57) ABSTRACT

A television viewer can shop for items related to a particular television program through use of a payment provider. The viewer can request that a search be performed for program-related items. The results of the search are then displayed to the viewer on the television screen. The viewer can then select items to be purchased and place them into a virtual shopping cart on the television screen. Payment for the items is then processed by the payment provider.

### BACKGROUND

1. Field of the Invention

The present invention generally relates to marketing and purchasing via mass media outlets, and in particular, to tailored marketing and funding of payment requests by a payment provider through the use of broadcast and internet media outlets, such as television.

2. Related Art

Home shopping allows consumers to purchase items from their home, as opposed to visiting brick and mortar stores to make their purchases. Home shopping can include mail or telephone ordering from catalogs, telephone ordering in response to advertisements in print or electronic media such as television, periodicals and radio, and online shopping. Home shopping typically includes electronic retailing, through the use of television-based and e-commerce companies.

Online shopping or online retailing typically requires a buyer to visit a particular seller's website using the Internet, select items to be purchased and buy them through the use of a payment provider, such as PayPal, Inc. of San Jose, Calif., and/or by use of a virtual shopping cart and checkout process. Such payment providers can make transactions easier and safer for the parties. Payment providers enable payments to be made through many different convenient methods. When making a payment, the payer, user of the services, or consumer typically specifies a funding source for the payment. Examples of funding sources can be an account with the payment provider, a credit card, a bank or checking account, or the like. When the user specifies a funding source, the payment provider may process the payment request to determine whether the user has sufficient funds or credit to make the payment. If so, the payment request is approved, and the purchase is completed. However, if there are insufficient funds or credit, the payment request may be denied, resulting a lost sale for the seller or payee and a lost purchase or payment by the buyer or payer.

Home shopping via the use of television typically includes the viewing of one or more shopping channels, which broadcast one or more infomercials, and telephoning their order and payment information to the retailer or shopping channel.

Recently, the advent of interactive television (ITV or iTV) has allowed television viewers to interact with a television and/or television content as they view it. Viewers may interact with the television content by raising or lowering the volume, changing the camera angle view, or by ordering a movie on demand, for example. ITV can include: (1) interactivity with a television set, which changes how viewers control the viewing of television content, such as by fast-forwarding or rewinding through a television program; (2) interactivity with television programming, in which the television program content changes based on viewer input, such as by viewer polling; or (3) interactivity with television-related content, which includes television commerce (i.e., purchasing items through the television set top box connection) and may include coordination with Internet-accessible devices such as computers, mobile devices, and the like. Typically, the interactions between the viewer and the broadcast service provider occur through a set top box.

### SUMMARY

In one embodiment, the present invention describes an electronic payment processing system including a memory storing user account information, wherein the information comprises funding sources for a user account and any restrictions on the funding sources, and one or more processors in communication with the memory configured to: receive by a payment provider, a request from a television program viewer for a payment for a product placed into a virtual shopping cart on a television screen, determine information about the viewer, a payment amount, and a payee, determine whether the viewer has an account with the payment provider that can be used to make the payment, and process the payment to the payee. In some embodiments, the one or more processors in communication with the memory is further configured to: receive a request from the television program viewer to perform a product search based on the television program, perform the product search, and display the results to the viewer on the television screen. In some embodiments, the product search is performed based on the topic, contents, style, type, or a combination thereof, of the television program. In further embodiments, the product search is tailored according to the specifications of the viewer. In some embodiments, the one or more processors in communication with the memory is further configured to transmit the status of the payment from the payment provider to the viewer. In some embodiments, the request is transmitted via the viewer pushing a button on a remote control to a television. In further embodiments, if the viewer does not have an account with the payment provider, the one or more processors is further configured to set up a user account for the viewer with the payment provider.

In another embodiment, the present invention describes a non-transitory machine-readable medium including a plurality of machine-readable instructions which when executed by one or more processors of a server are adapted to cause the server to perform a method including: receiving a request for a payment to a payee from a television viewer for an item placed in a virtual shopping cart located on a television screen by the television viewer, receiving authorization from the television viewer to access account information with a payment provider, determining available funding sources for the television viewer, receiving selected funding sources from the television viewer, and processing the request for payment to a payee based on the selected funding sources. In some embodiments, the non-transitory machine-readable medium, further includes notifying the payee of the television viewer's request for payment, payment, or both. In some embodiments, the non-transitory machine-readable medium, further includes displaying the results of the payment to the television viewer on a television screen. In some embodiments, the non-transitory machine-readable medium, further includes: receiving a request for an item search based on a television program, displaying search options to the television viewer, performing the item search based on parameters selected by the television viewer, and displaying the results of the item search to the television viewer on a television screen. In some embodiments, the authorization includes the television viewer providing user account verifying information.

In another embodiment, the present invention describes a method of performing a financial transaction, including: receiving, electronically by a processor of a payment provider, a request from a viewer for the performance of a product search based on a television program; determining information about the television program and performing the product search based on that information; presenting the search results to the viewer on a television screen; and receiving, electronically by a processor of a payment provider, a second request from the viewer to purchase selected items placed into a virtual shopping cart.

In some embodiments, the method further includes: determining information about the viewer, a payment amount, and the payee, determining whether the viewer has an account with the payment provider that can be used to make the payment, and processing the payment to the payee. In some embodiments, the method further includes setting up an account for the viewer with the payment provider if the payment provider determines that the viewer doesn't have an account or the viewer's account is invalid. In some embodiments, the method further includes displaying a confirmation of purchase message to the viewer on the television screen. In some embodiments, the request from a viewer for the performance of a product search based on a television program is initiated by the viewer pressing a button on a television remote or television touch screen. In some embodiments, the viewer places selected items into a virtual shopping cart by touching a representation of those items on a television touch screen. In some embodiments, the method further includes notifying a payee of the second request from the viewer to purchase selected items. In some embodiments, the product search is conducted without any viewer input.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process in requesting a television program-based search, processing and performing the request, selecting items for purchase and paying for those items using a payment provider according to one embodiment of the invention;

FIG. 2 is a flowchart showing a process for a payment provider in processing a payment using information from a television viewer according to one embodiment of the invention;

FIG. 3 is block diagram of a networked system suitable for implementing the process of FIGS. 1 and 2 according to an embodiment; and

FIG. 4 is a block diagram of a system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Embodiments of the present invention provide consumers with the ability to request the performance of a television program-related product search while watching the television, with the use of a payment provider. Accordingly, embodiments of the present invention allow a payment provider to conduct a search tailored to a particular television program, display the results of the search to the television viewer on a television screen, allow the viewer to select items from the search for purchase and place them into a virtual shopping cart, and checkout and pay for the selected items using a user account with the payment provider. For example, if a television viewer is watching a sports program, the search results may include tickets for a related sports event, sports memorabilia, sports gear, and the like. Optionally, the television viewer may select search criteria prior to conducting the search. Instead of, or in addition to, the selectable search criteria, the viewer may filter the results after the search has been conducted. The viewer then may select items for purchase and payment is processed via the payment provider. Thus, the methods and systems of the present invention provide television viewers with a mechanism to shop for necessary or wanted items from their homes, solely through the use of their television.

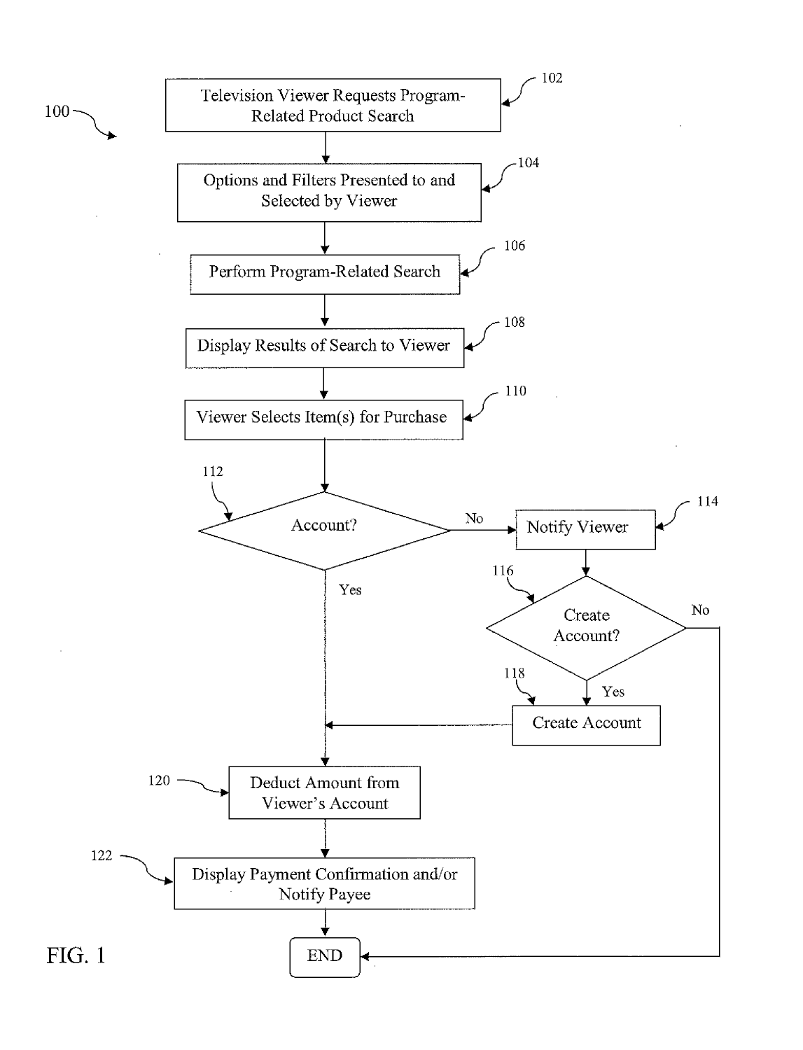

FIG. 1 is a flowchart 100 showing a process in requesting and performing a television program-related search, displaying the results of the search to the viewer and paying for selected items from the search via use of a payment provider. Initially, the television viewer turns on the television (step not shown). Preferably, the television is connected to a set top box or digibox. The set top box can be configured to receive terrestrial, cable, satellite, digital, IP, or any other type of signal source available. Once the television viewer has selected a television program of interest, the viewer can initiate a television program-related product search at step 102. The request for a program-related product search can be initiated by any number of mechanisms including, but not limited to, pressing a button or a series of buttons on a remote control, selecting an icon or a series of icons on the television screen (wherein the television screen may have touch screen capabilities), selecting a search option from a television menu, and/or any combination of the above. Optionally, at step 104, the television screen may display search criteria or filtering options to the viewer as to how the search is to be conducted. The television viewer may select preferred options or filters. This step may take place either before the search is performed, after the search is performed, or both. For example, the television viewer may only want to view the most popular items, or the viewer may want to view a particular category of items such as clothing, or appliances that were seen or used by actors or individuals in the television program, or the viewer may want to view the results in alphabetical order. Optionally, the viewer may structure the search so that only clothing items are initially displayed and then filter the displayed results so that they are displayed with the most popular items displayed first.

At step 106, the program-related product search is performed. The search may be performed by any entity but preferably is performed by a payment provider. If the programming schedule is available in advance of the show time, then the search may be performed before the request by the viewer is initiated. The viewer may then just be requesting the results to be displayed on their television screen upon viewing the program. The viewer may optionally then tailor the displayed results to their liking. Alternatively, or additionally, the viewer may request the results of the search in advance of the program or after the program has been aired, if the viewer sees that a particular program of interest is scheduled by, for example, looking at a guide channel.

At step 108, the results of the program-related product search are displayed to the viewer on the television screen. Typically, this can be accomplished by utilizing another channel, the menu of the television, or by displaying the results simultaneously with the program and/or channel that the television is set to, as in a picture-in-picture display. The results can be depicted in any fashion and can include icon images of the items for sale.

At step 110, the viewer selects the item(s) for purchase. This can be accomplished by any number of mechanisms including, but not limited to, scrolling through the items and selecting them via the remote control or, if the television has touchscreen capabilities, touching the icon of the item(s) for purchase and dragging them or placing them in a virtual shopping cart. The virtual shopping cart can be displayed simultaneously on the same screen as the item(s) and/or program or can be on a different screen and/or channel. From the screen with the virtual shopping cart, the viewer can begin the checkout process. The checkout process typically involves payment by the viewer for the item(s) selected for purchase, as well as a review of the selected item(s) and quantities. From the virtual shopping cart, the viewer will be able to modify their selected item(s) by adding or deleting from the list of selected item(s).

At step 112, the viewer selects payment for the selected item(s) by a payment provider such as PayPal, Inc. of San Jose, Calif. It is then determined whether the viewer has an account with a payment provider. This can be done by searching an account database of the payment provider with the recipient information. If the viewer doesn't have an account with a payment provider, then the viewer is notified that no account exists for them to make the payment at step 114. The viewer can then determine whether to create a payment provider account at step 116. If no account exists, the viewer may be asked to enter information again, as the original information may have been entered incorrectly. If still no account is found, an account may be created or registered at step 118. To register or create an account, the recipient typically enters the payment provider site, such as through an interactive television, PC, laptop, smart phone, computing tablet, or other computing device. Account creation may include the payment provider requesting certain information from the viewer, such as a username, email address, phone number, credit card information, bank information, personal identification number (PIN), password, and/or address. Using the requested information, the payment provider creates an account for the viewer at step 118. Note that if an account was found, but not valid, such as expired funding source, expired account, etc., the payment provider may only need to request a limited amount of information to re-activate the account, such as a valid funding source. Without a response or with an affirmative indication that the recipient does not want to open an account, the process ends. If the viewer decides not to create a payment provider account, then the process stops. An electronic message is optionally sent back to the viewer indicating that no payment would be made for the selected item(s).

If the viewer has a payment provider account or has created an account at step 118, then the total or partial amount of the invoice for the selected item(s) is deducted from the viewer's account at step 120. This may require the viewer entering account identifying information, such as a username, email address, mobile phone number, passcode or PIN, but would not necessarily require the viewer to log onto the payment provider website. If the viewer wants to pay only a partial amount of the invoice for the selected item(s), then the viewer may need to enter an amount to be paid. Optionally, the viewer may also indicate a particular funding source to deduct the amount from. Once the full or partial amount is deducted from the viewer's account, then optionally, an electronic message is sent to the viewer or displayed on the television screen confirming payment of the invoice at step 122. Optionally, the payee is also notified at step 122.

Optionally, once a payment provider account is created (step 118) or found for the viewer, the viewer may create funding limits for the particular television or particular invoice via the payment provider. The viewer may set specific limits or different limits may be provided by the payment provider for the viewer to select. Examples of limits include: 1) a dollar amount to be funded per transaction, 2) a dollar amount to be funded per day, per week, per month, or other time period, 3) a total number of transactions per day, per week, per month, or other time period, 4) certain categories for funding or certain categories for not funding, 5) certain payees for funding or certain payees for not funding, 6) different funding limits for different categories of purchases, and/or 7) a time limit for when the funding will be available or will expire. Various combinations of the above or other limits can be set for the funding via the viewer's payment provider account. This would help avoid or minimize the charges if another viewer uses the original viewer's account to make purchases. Thus, depending upon how the television and account are set up, the viewer(s) may not need to re-enter payment provider account information once it is entered initially.

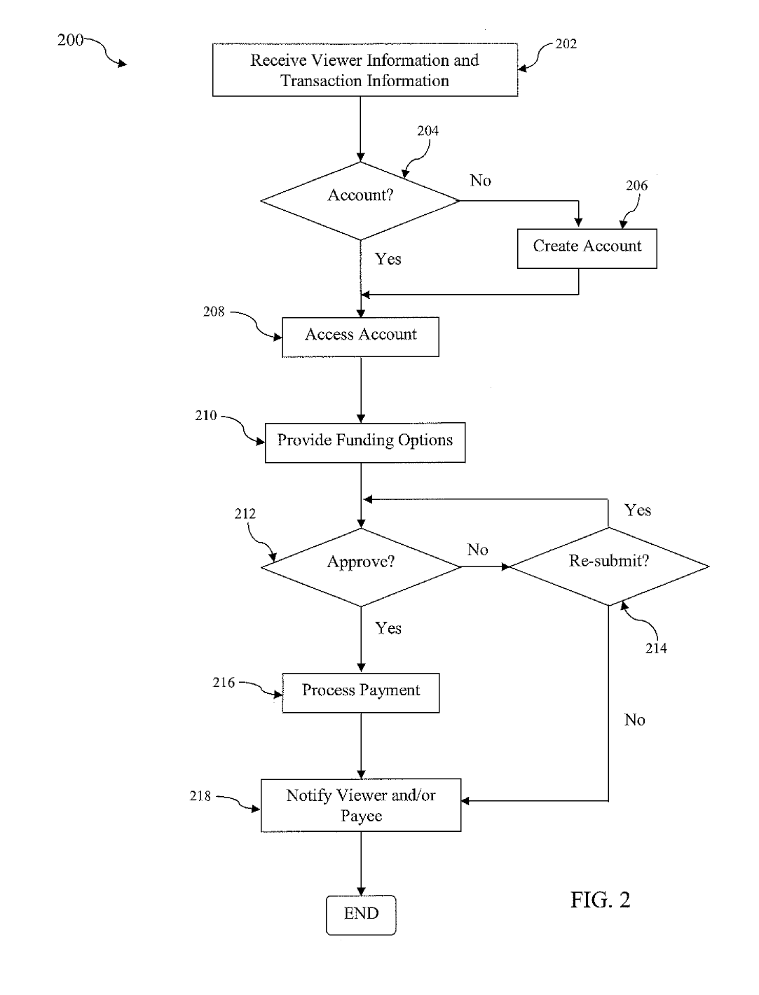

FIG. 2 is a flowchart 200 showing a process for a payment provider in making a payment using a television according to one embodiment. At step 202, the payment provider receives viewer and transaction information. Transaction information may include viewer identification, merchant identification, including a merchant account identifier, and invoice information, including, for example, price, tax, shipping costs, and totals. The transaction information may be received by an indication that the viewer is ready for check-out or payment of selected invoice(s). For example, the viewer may indicate a desire to pay by simply touching a button or series of buttons on the remote control or by touching “checkout” icons on a touchscreen television and the details of the transaction would then automatically be transmitted to the payment provider. As an alternative, the viewer may enter or select the desired invoices to be paid by placing them in a cart on the payment provider site, which would appear on the television screen, and selecting a button or link, such as “Checkout,” “Pay,” “Continue,” etc. This may transmit or lead to transmitting the transaction information to the payment provider. The viewer is the customer, consumer, or the entity/person making a payment. Viewer information may include the user's name, email address, phone number, username, password, PIN, and/or other identifier for the payment provider. The payment provider may receive the viewer information without accessing the payment provider web site, such as by the use of the television, set top box, email or text messaging. The payment provider may receive the viewer information by accessing the payment provider web site, such as through use of a television capable of an Internet connection, PC, laptop, mobile phone, smart phone, or other electronic or computing device.

Transmittal of the viewer and transaction information may also be accomplished by the viewer entering a PIN or passcode along with the viewer selecting or clicking on “Accept” or “Yes.”

At step 204, the payment provider determines whether the viewer has an account with the payment provider, based on the information received at step 202. The payment provider may make the determination by searching an account database using the information provided. Results may include no account exists, an active account exists, or an inactive account exists. If the payment provider does not find a valid or active account, the payment provider may create an account for the viewer, at step 206, if desired by the viewer This may include the user entering requested information, such as name, email address, phone number, mailing address, credit card or bank information, social security number, password, PIN, etc.

Once the viewer's account is created (step 206) or found (step 204), the payment provider accesses the account at step 208. Accessing the account allows the payment provider to determine certain information about the viewer and/or the account, such as account limits or restrictions, available funding sources, etc. It also enables the payment provider to make any determinations about the authenticity of the viewer.

Optionally, the payment provider determines funding options for the viewer and the transaction, such as based on the viewer information and/or the transaction information. For example, the viewer may have specific funding options associated with the account. Conventional funding options may include a viewer bank/checking account and one or more credit cards. The viewer may also have limits to these conventional funding options, such as limits imposed by the instrument or a recipient controlling the instrument.

The available funding sources are then provided to the viewer at step 210. The funding sources may include an identification of the person, such as the viewer's name or email address. Other information may include any restrictions for the funding source, such as limits. In one embodiment, the payment provider only provides or shows sources that can be used with the particular transaction associated with the particular viewer. Thus, even though the viewer may be associated with several different funding sources, the specifics of the transaction may exclude one or more of those sources. In other embodiments, all funding sources are shown to the viewer regardless of whether one or more may be unusable due to the details of the transaction.

Based on the funding sources provided by the payment provider, the viewer selects one or more funding sources as payment for the transaction. Selection may be by simply touching, highlighting or checking a box next to desired ones of the funding sources or other selection means, such as clicking on the desired funding source. The selected funding source(s) are then communicated to and received by the payment provider.

Next, the payment provider determines whether to approve the payment at step 212. The determination process may include checking on limits or restrictions associated with the viewer's account, the details of the transaction or purchase, and the availability of one or more selected funding sources. Any number of reasons may cause the transaction to be declined, such as any indication of a fraudulent transaction, the type of transaction, purchase, or merchant was specifically forbidden, spending limits have been reached or exceeded, and/or insufficient funds for the transaction amount. For example, the viewer may have selected one or more funding sources that are not available for this transaction or viewer based restrictions placed on the funding sources and/or the funding sources selected are insufficient to fund the transaction amount.

If the requested payment is not approved, the viewer may have the option of re-submitting the request by changing one or more parameters, such as adding a funding source and/or changing a funding source. If the viewer wishes to re-submit the request, as determined at step 214, the viewer re-submits the request to pay the invoice and the payment provider may receive new funding sources. Processing of the payment would then continue as before. If the viewer does not wish to re-submit the request or the viewer is not given the option of re-submitting (such as in the case where the reason for not approving the transaction was based on the actual type of transaction), then the transaction ends without a payment. Optionally, at step 218, the viewer and/or payee is notified that the transaction has not been completed.

However, if the transaction request is approved, the payment provider processes the payment at step 216. The processing may include debiting the appropriate amount of funds from each of the specified funding sources and/or accounts, crediting the appropriate amount of funds to the payee, and notifying the payee that the payment request has been approved. Notification can be by any means, including email, text, through the payee's website, etc. Once notified, the payee can release, ship, or otherwise transfer the purchase to the viewer or simply further notify the viewer that the invoice has been paid. Optionally, the viewer and/or payee may be notified by the payment provider that the invoice has been paid at step 218. The notification may be through email, text, phone call, or notification on the viewer's account page with the payment provider. The viewer and/or payee may be informed about various details of the transaction, including amount of funds used, total amount of the transaction, description of the purchase, identification of the merchant, payee or third party, and the date of the transaction.

Therefore, using embodiments of the present invention, a television viewer may be able to make a purchase or pay an invoice, where in the past, the viewer may not have been able to make the purchase. The viewer may be able to purchase item(s) unavailable for purchase through other means, or may be able to make a purchase more readily than through the use of other means. This results in a payment that otherwise may not have happened. The viewer can control the use of their funds at any time, which limits exposure or abuse of these additional funding sources.

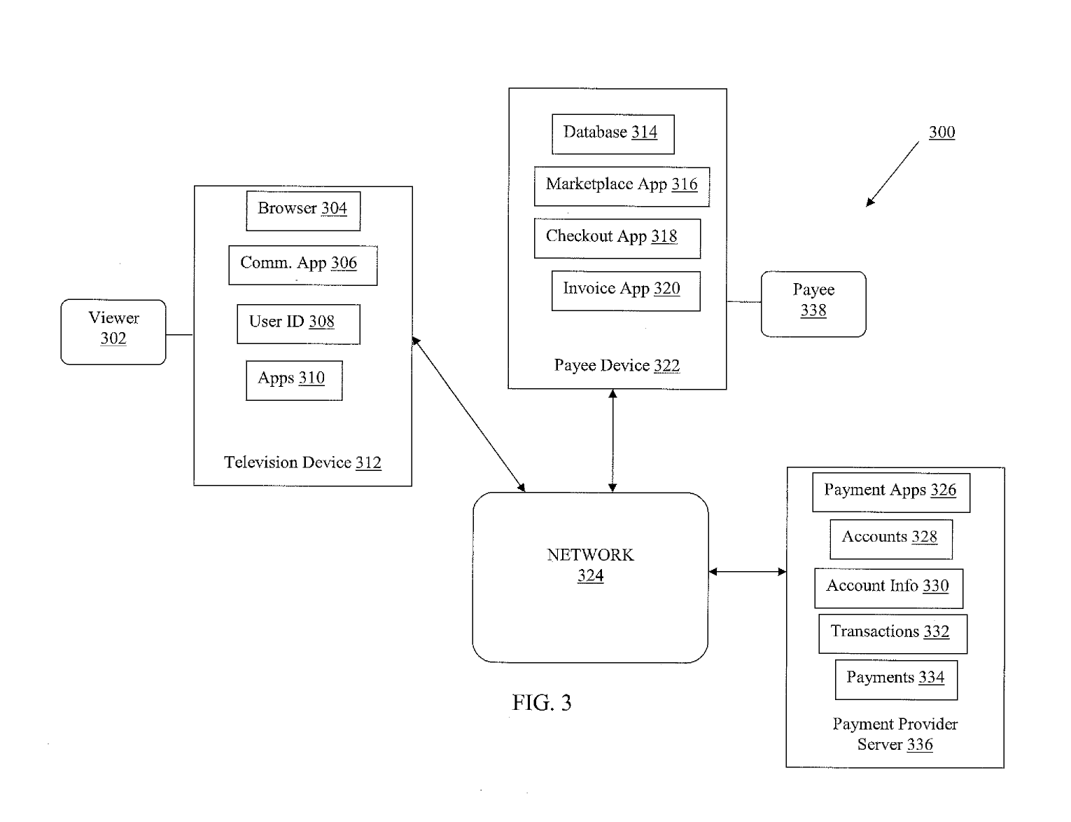

FIG. 3 is a block diagram of a networked system 300 configured to handle a financial transaction between a viewer and a payee, such as described above, in accordance with an embodiment of the invention. System 300 includes a television device 312, a payee device 322, and a payment provider server 336 in communication over a network 324. Payment provider server 336 may be maintained by a payment provider, such as PayPal, Inc. of San Jose, Calif. A viewer 302, utilizes television device 312, and a payee 338 utilizes payee device 322, where the television device 312 is used to send a payment request of an invoice generated by the viewer selecting item(s) for purchase to the payment provider and perform a payment transaction with a payee device 322 using payment provider server 340.

Television device 312, payee device 322, and payment provider server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 324.

Network 324 may be implemented as a single network or a combination of multiple networks. For example, in various embodiments, network 324 may include the Internet or one or more intranets, landline networks, wireless networks, and/or other appropriate types of networks.

Television device 312 and payee device 322 may be implemented using any appropriate hardware and software configured for wired and/or wireless communication over network 324. For example, in one embodiment, the television device 312 may be implemented as any type of television while the payee device 322 may be implemented as a personal computer (PC), a smart phone, a mobile phone, personal digital assistant (PDA), laptop computer, and/or other types of computing devices capable of transmitting and/or receiving data, such as a television or iPad™ from Apple™.

Television device 312 may include one or more browser applications 304 which may be used, for example, to provide a convenient interface to permit viewer 302 to browse information available over network 324. For example, in one embodiment, browser application 304 may be implemented as a web browser configured to view information available over the Internet. Television device 312 may also include one or more applications 310 which may be used, for example, to provide client-side processing for performing desired tasks in response to operations selected by viewer 302. In one embodiment, a toolbar application may display a user interface in connection with browser application 304 as further described herein. Television device 312 may further include other applications 310 as may be desired in particular embodiments to provide desired features to television device 312. For example, other applications 310 may include security applications for implementing client-side security features, programmatic client applications for interfacing with appropriate application programming interfaces (APIs) over network 324, or other types of applications. Applications 310 may also include email, texting, voice and IM applications that allow viewer 302 to send and receive emails, calls, and texts through network 324, as well as applications that enable the viewer to arrange to make payments through the payment provider as discussed above. Television device 312 includes one or more user identifiers 308 which may be implemented, for example, as operating system registry entries, cookies associated with browser application 304, identifiers associated with hardware of television device 312, or other appropriate identifiers, such as used for payment/user/device authentication. In one embodiment, user identifier 308 may be used by a payment service provider to associate viewer 302 with a particular account maintained by the payment provider as further described herein. A communications application 306, with associated interfaces, enables television device 312 to communicate within system 300.

The payee device 322 may be maintained, for example, by a merchant or seller offering various products and/or services in exchange for payment to be received over network 324. Generally, the payee device 322 may be maintained by anyone or any entity that receives money, which includes charities as well as retailers. The payee device 322 includes a database 314 identifying available products and/or services (e.g., collectively referred to as “items”) which may be made available for viewing and purchase by viewer 302. Accordingly, the payee device 322 also includes a marketplace application 316 which may be configured to serve information over network 324 to browser 304 of television device 312. In one embodiment, viewer 302 may interact with marketplace application 316 through browser applications over network 324 in order to view various products or services identified in database 314.

The payee device 322 also may include a checkout application 318 which may be configured to facilitate the purchase by viewer 302 of goods or services identified by marketplace application 316. Checkout application 318 may be configured to accept payment information on the viewer 302 through payment service provider server 336 over network 324. For example, checkout application 318 may receive and process a payment confirmation from payment service provider server 336, as well as transmit transaction information to the payment provider and receive information from the payment provider (e.g., a transaction ID). Checkout application 318 may also be configured to accept one or more different funding sources, including funding sources, for payment.

The payee device 322 may also include an invoice application 320 which may be configured to bill the viewer 302 for the provision of goods and services. The invoice application 320 may bill the viewer 302 once or on a routine basis. The invoice application 320 may transmit information to the viewer via the television device browser 304, any application 310 and/or communication application 306.

Payment provider server 336 may be maintained, for example, by an online payment service provider which may provide payment between viewer 302 and the payee 338. In this regard, payment provider server 336 includes one or more payment applications 326 which may be configured to interact with television device 312, and/or payee device 322 over network 324 to facilitate the payment for goods or services rendered to viewer 302.

Payment provider server 336 also maintains a plurality of user accounts 328, each of which may include account information 330 associated with individual users. For example, account information 330 may include private financial information of users of devices such as account numbers, passwords, device identifiers, user names, phone numbers, credit card information, bank information, or other financial information which may be used to facilitate online transactions by viewer 302. Advantageously, payment application 326 may be configured to interact with payee device 322 on behalf of viewer 302 during a transaction with checkout application 318 to track and manage purchases made by viewer 302 and which funding sources are used.

A transaction processing application 332, which may be part of payment application 326 or separate, may be configured to receive information from a viewer device 312 and/or payee device 322 for processing and storage in a payment database 334. Transaction processing application 332 may include one or more applications to process information from viewer 302 and/or payee 338 for processing a payment using a viewer's funding source as described herein. Other funding sources may also be processed through this application. Payment application 326 may be further configured to determine the existence of and to manage accounts for viewer 302, and optionally payee 338, as well as create new accounts if necessary, such as the set up, management, and use of various funding sources.

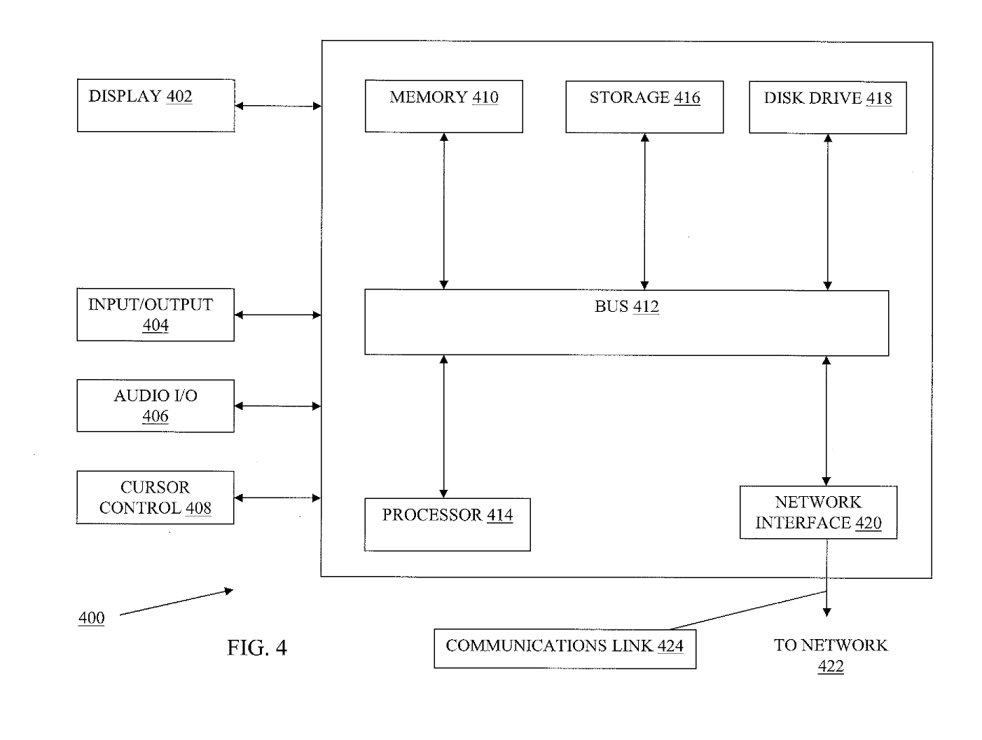

FIG. 4 is a block diagram of a computer system 400 suitable for implementing one or more embodiments of the present disclosure. In various implementations, the user device may comprise a personal computing device (e.g., a television, personal computer, laptop, smart phone, PDA, Bluetooth device, key FOB, badge, etc.) capable of communicating with the network. The payee and/or payment provider may utilize a network computing device (e.g., a network server) capable of communicating with the network. It should be appreciated that each of the devices utilized by viewers, payees (i.e., merchants), and payment providers may be implemented as computer system 400 in a manner as follows.

Computer system 400 includes a bus 412 or other communication mechanism for communicating information data, signals, and information between various components of computer system 400. Components include an input/output (I/0) component 404 that processes a user (i.e., viewer, payee and/or payment provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a merchant server, or a payment provider server via network 324. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. The above description focuses on a third party invoice to be paid in whole or in part by a recipient on behalf of a sender. However, the payment or request for payment need not be for a generated invoice, but can be for an intended purchase in which an invoice has not yet been created. For example, a sender may want to purchase an item from a merchant or third party, where the item is placed in a cart, but not yet paid for. Thus, different types of requests for payment by a recipient on behalf of a sender may also be suitable. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic payment processing system comprising:
a memory storing user account information, wherein the information comprises funding sources for a user account and any restrictions on the funding sources; and
one or more processors in communication with the memory configured to:
receive by a payment provider, a request from a television program viewer for a payment for a product placed into a virtual shopping cart on a television screen;
determine information about the viewer, a payment amount, and a payee;
determine whether the viewer has an account with the payment provider that can be used to make the payment; and
process the payment to the payee.

2. The electronic payment processing system of claim 1, wherein the one or more processors in communication with the memory is further configured to:
receive a request from the television program viewer to perform a product search based on the television program;
perform the product search; and
display the results to the viewer on the television screen.

3. The electronic payment processing system of claim 2, wherein the product search is performed based on the topic, contents, style, type, or a combination thereof, of the television program.

4. The electronic payment processing system of claim 2, wherein the product search is tailored according to the specifications of the viewer.

5. The electronic payment processing system of claim 1, wherein the one or more processors in communication with the memory is further configured to transmit the status of the payment from the payment provider to the viewer.

6. The electronic payment processing system of claim 1, wherein the request is transmitted via the viewer pushing a button on a remote control to a television.

7. The electronic payment processing system of claim 1, wherein if the viewer does not have an account with the payment provider, the one or more processors is further configured to set up a user account for the viewer with the payment provider.

8. A non-transitory machine-readable medium comprising a plurality of machine-readable instructions which when executed by one or more processors of a server are adapted to cause the server to perform a method comprising:
receiving a request for a payment to a payee from a television viewer for an item placed in a virtual shopping cart located on a television screen by the television viewer;
receiving authorization from the television viewer to access account information with a payment provider;
determining available funding sources for the television viewer;
receiving selected funding sources from the television viewer; and
processing the request for payment to a payee based on the selected funding sources.

9. The non-transitory machine-readable medium of claim 8, further comprising notifying the payee of the television viewer's request for payment, payment, or both.

10. The non-transitory machine-readable medium of claim 8, further comprising displaying the results of the payment to the television viewer on a television screen.

11. The non-transitory machine-readable medium of claim 8, further comprising:
receiving a request for an item search based on a television program;
displaying search options to the television viewer;
performing the item search based on parameters selected by the television viewer; and
displaying the results of the item search to the television viewer on a television screen.

12. The non-transitory machine-readable medium of claim 8, wherein the authorization comprises the television viewer providing user account verifying information.

13. A method of performing a financial transaction, comprising:
receiving, electronically by a processor of a payment provider, a request from a viewer for the performance of a product search based on a television program;
determining information about the television program and performing the product search based on that information;
presenting the search results to the viewer on a television screen; and
receiving, electronically by a processor of a payment provider, a second request from the viewer to purchase selected items placed into a virtual shopping cart.

14. The method of claim 13, further comprising:
determining information about the viewer, a payment amount, and the payee;
determining whether the viewer has an account with the payment provider that can be used to make the payment; and
processing the payment to the payee.

15. The method of claim 14, further comprising setting up an account for the viewer with the payment provider if the payment provider determines that the viewer doesn't have an account or the viewer's account is invalid.

16. The method of claim 13, further comprising displaying a confirmation of purchase message to the viewer on the television screen.

17. The method of claim 13, wherein the request from a viewer for the performance of a product search based on a television program is initiated by the viewer pressing a button on a television remote or television touch screen.

18. The method of claim 13, wherein the viewer places selected items into a virtual shopping cart by touching a representation of those items on a television touch screen.

19. The method of claim 13, further comprising notifying a payee of the second request from the viewer to purchase selected items

20. The method of claim 13, wherein the product search is conducted without any viewer input.
